(19) United States
(12) Patent Application Publication
(10) Pub. No.: US 2004/0108667 A1
(43) Pub. Date: Jun. 10, 2004

(54) Platform of a handcart

(76) Inventor: James Tsai, Taichung Hsien (TW)

Correspondence Address: BACON & THOMAS, PLLC, 625 SLATERS LANE, FOURTH FLOOR, ALEXANDRIA, VA, 22314

(21) Appl. No.: 10/315,089

(22) Filed: Dec. 10, 2002

(51) Int. Cl. B62B 1/00

(52) U.S. Cl. 280/40

(57) ABSTRACT

A handcart mainly comprises a main body and a platform. The main body comprises two wheel seats, two wheels and a retractable handle. The platform comprises a frame, an inclined front board at front end of the frame and a shell covering said frame. The frame comprises two side tubes, a front tube and two inner bars. The side tubes and the front tube are made from bending a single tube and the inner tubes are parallel to the side tubes and fix their front ends to the front tube. Each of the side tubes and the inner tubes is provided with an arched portion at the rear end thereof and mounts a plank on the inner side of the arched portion. A shaft runs through the wheel seats and openings on the planks of the side tubes and the inner tubes to pivot the frame on the main body. A front board having an inclined surface is mounted on the front tube. A shell is mounted on the frame but exposes the front board.

### FIELD OF THE INVENTION

The present invention relates to a handcart, and more particularly to a platform of a handcart.

### BACKGROUND OF THE INVENTION

U.S. Pat. No. 5,803,471 disclosed a conventional handcart which having supporting frame, two wheels and a platform. The platform in '471 is a plank element (it usually was made of metal) to be inserted into the bottom of a good for supporting it thereon. This kind of handcart was designed for carrying heavier goods so that the platform must be thicker to bear heavier goods thereon. It is easy to understand that a thicker platform will make the handcart heavier.

U.S. Pat. No. 6,053,541 taught a platform with holes thereon to reduce the weight thereof but the capacity of supporting heavier goods will be decreased.

### SUMMARY OF THE INVENTION

The primary objective of the present invention is to provide a handcart with a platform, which has a well capacity to support heavier goods thereon and is lighter in weight.

According to the objective of the present invention, a handcart of the present invention is mainly composed of a main body and a platform. The platform comprises a frame, which has two side tubes, a front tube and at least an inner bar. The side tubes have their rear ends connected with the main body and have their front ends coupled with the front tube respectively. The inner bar is located in between the side tubes to make the frame stronger in structure.

### BRIEF DESCRIPTION OF THE DRAWINGS

FIG. 1 shows a perspective view of a handcart of a prefer embodiment of the present invention, showing an extended position of a platform;

FIG. 2 shows a perspective view of the handcart of the prefer embodiment of the present invention, showing a collapsed position of the platform;

FIG. 3 shows an exploded view of the platform of the prefer embodiment of the present invention;

FIG. 4 shows a top view of the platform of the prefer embodiment of the present invention;

FIG. 5 shows a lateral view of the platform of the prefer embodiment of the present invention;

### DETAILED DESCRIPTION OF THE INVENTION

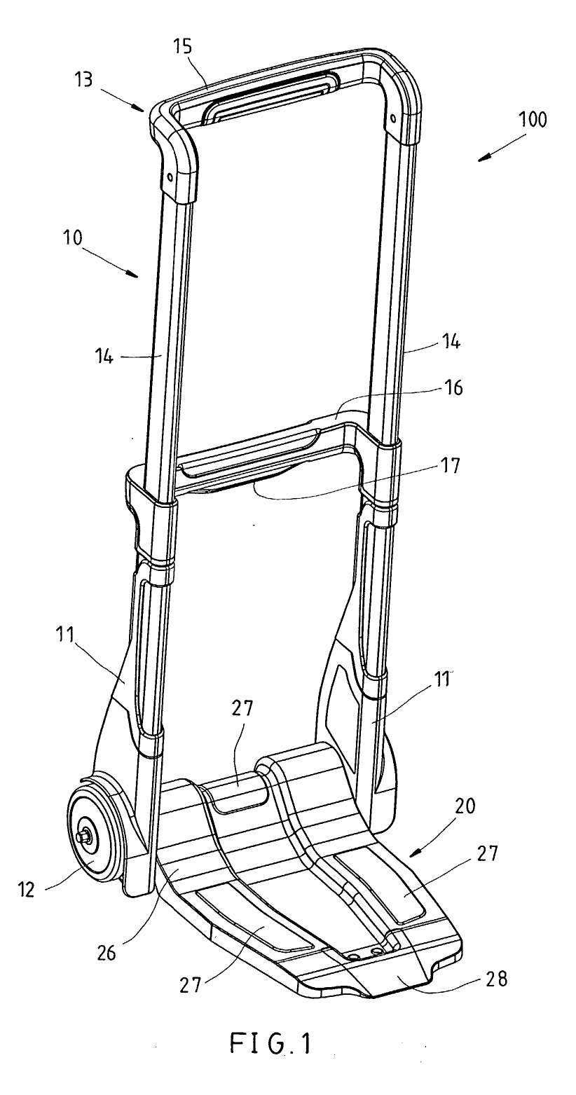

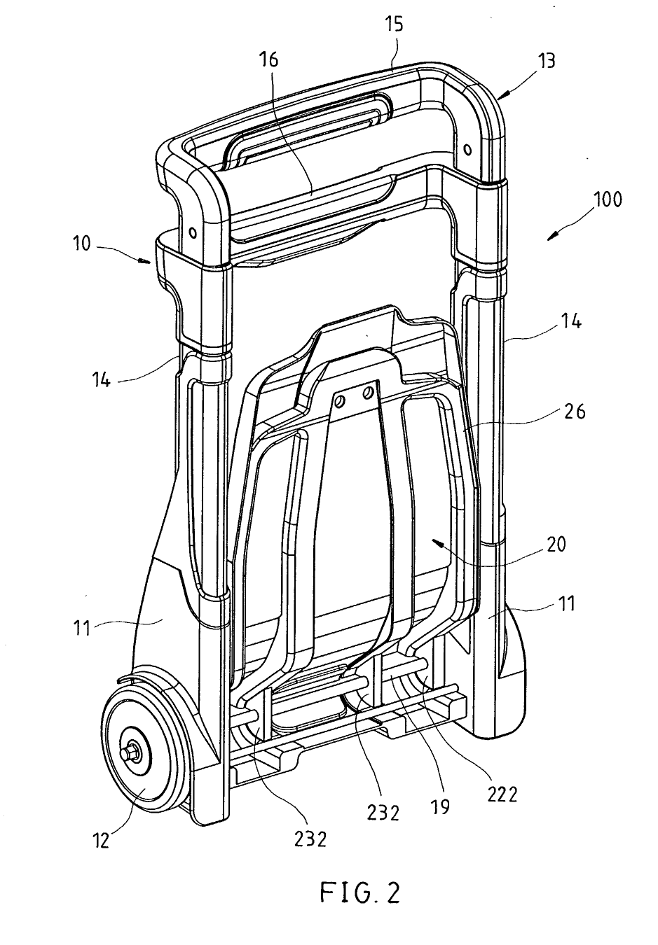

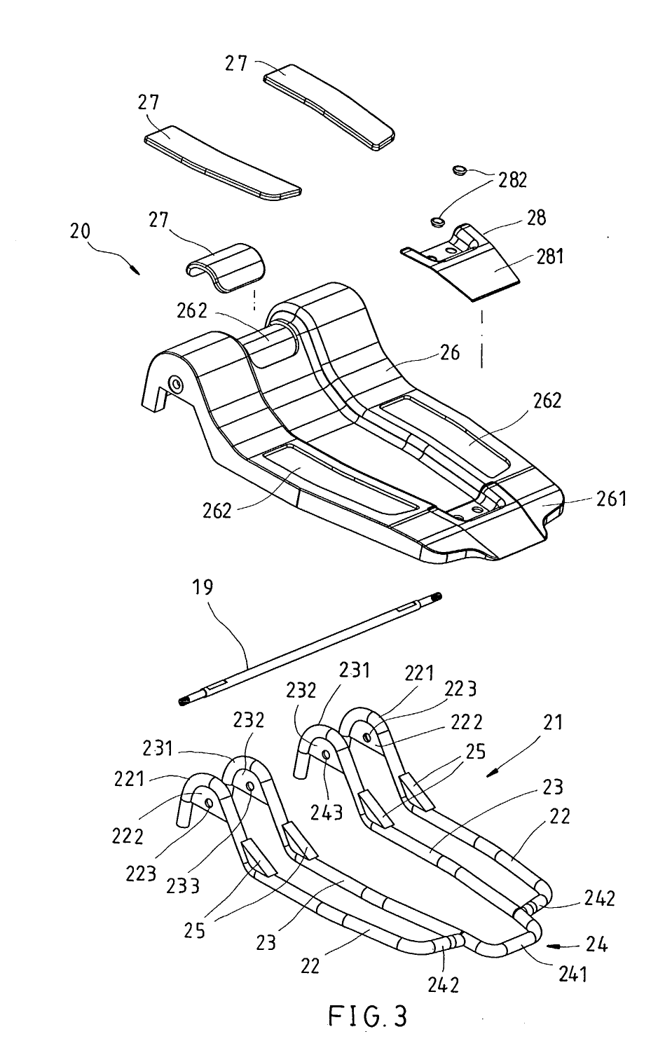

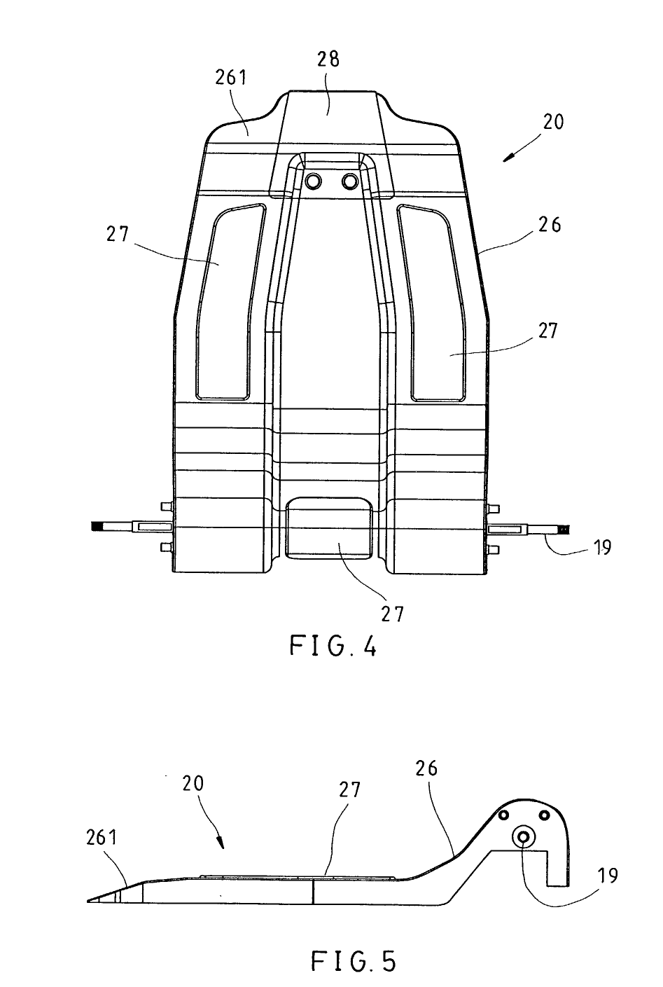

Please refer to FIG. 1 and FIG. 2, a handcart 100 of the prefer embodiment of the present invention mainly comprises a main body 10 and a platform 20, wherein

The main body 10 comprises two wheel seats 11, two wheels 12 pivoted on the wheel seats 11 respectively and a retractable handle 12. The retractable handle 13 has two retractable tube sets 14, a handle bar 15 and a control bar 16. The retractable tube sets 14 have their ends mounted on the wheel seats 11 respectively. The handle bar 15 has its ends coupled with the distal ends of the retractable tube sets 14, and the control bar 16 has it ends thereof connected with the retractable tube sets 14 below the handle bar 15. The control bar 16 has a button 17 thereon to lock and release the retractable tube sets 14.

The platform 20 is pivoted on the main body 10 by means of a shaft 19 running through wheel seats 11 and the rear of the platform 20 such that the platform 20 can be turned between a collapsed position (FIG. 2), at which the platform 20 is turned towards the main body 10 and rests on the main body 10, and an extended position, at which the platform 20 is turned away from the main body 10 about 90 degrees (FIG. 1). The platform 20 also can be simply fixed coupled with the main body 10.

The platform 20 is composed of a frame 21, a shell 26, three resistance elements 27 and a front board 28, wherein

The frame 21 is composed of two side tubes 22, two inner bars 23 and a front tube 24. The side tubes 22 and the inner bars 23 are substantially parallel and front tube 24 is fixed with the front ends of the side tubes 22 and the inner bars 23. In the present embodiment, the frame 21 is made from three bent tubes, one of which is bent as a U-shaped to form a first section of the front tube 24 at midsection thereof and the inner bars 23 at parallel sections thereof. The other two tubes are L-shapes, each of which forms a second section 242 of the front tube 24 at a side and the side tube 22 at the other side. The distal ends of the second sections 242 are welded to the inner bars 23 to form the frame 21.

It has to be mentioned here, the inner bars 23 are tubes in the present prefer embodiment, in fact, they also can be bar elements. It also can add more inner bars (not shown in FIGS.) which couple their opposite ends with the side tubes 22 to increase the capacity of the frame 21 to support goods thereon.

Each of the side tubes 22 and the inner bars 23 has an arch portion 221 and 231 at rear end thereof. Each arched portion 221 or 231 is fixed with a plank 222 or 232 at the inner side thereof on which has an opening 223 or 233 for the shaft 19 running through. Triangular blocks 25 are mounted on the side tubes 22 and the inner bars 23 at the inner edges of the arched portions 221 and 231 thereof to enhance the strength of the frame 21.

The shell 26 covers the side tubes 22, the inner bars 23 and the front tube 24 therein. The shell 26 has an inclined surface 261 at front end thereof substantially. In the present prefer embodiment, the shell 26 is made from injection molding. The frame 21 was put into a mold before injecting such that the shell 26 will be molded on the frame 21 directly.

The resistance elements 27 are mounted in slots 262 on the top surface of the shell 26. The resistance elements 27 are rubber blocks in the present prefer embodiment for providing the goods (not shown) put on the platform 20 a friction to prevent it from slipping.

The front board 28 is mounted on the shell 26 at the front end thereof. The front board 28 has an inclined surface 281 parallel to the inclined surface 261 of the shell 26. In the present prefer embodiment, the front board is a metal board mounted on the shell 26 by two screws 282 and is bent to form the inclined surface 281.

With the combination as described above, the platform 20 is mainly constructed from the frame 21 which is constructed from tubes 22, 23 and 24 so that the platform 20 is lighter in weight but still has a well capacity to support heavier goods (not shown) thereon. The inclined surfaces 251 and 261 of the front board 25 and the shell 26 can make the platform 20 can be inserted into the bottom of a good directly. The platform 20 is pivoted with the main body 10 by means of jointing the shaft 19 with the tubes 22 and 23 of the frame 21 directly that makes the platform 20 having a strong structure coupled with the main body 10.

What is claimed is:

1. A handcart, comprising a main body and a platform, wherein the main body comprises two wheel seats, two wheels and a handle and said platform comprises a frame, which has two side tubes, a front tube and at least an inner bar, wherein said front tubes have their rear ends connected with said main body of the handcart and their front ends fixed with said front tube and said inner bar is located in between the said side tubes having an end thereof fixed with said front tube and the other end thereof connected with the main body.

2. The handcart as defined in claim 1, wherein said frame has a U-shaped tube to form a first section of said front tube at midsection thereof and said inner bars at parallel sections thereof and two L-shaped tubes to form second sections of said front tube at sides thereof and said side tubes at the other sides thereof wherein said second sections are fixed to said inner bars respectively.

3. The handcart as defined in claim 1, wherein each of said side tubes and said inner bar is provided with a plank at rear ends thereof on which has an opening for a shaft running through to pivot said platform on the main body.

4. The handcart as defined in claim 1, wherein each of said side tubes and said inner bar has an arched portion at rear ends thereof and a plank mounted on the inner side of said arched portion, wherein each of said planks is provided with an opening for a shaft running through to pivot the platform on the main body.

5. The handcart as defined in claim 1, wherein said platform further comprises a shell mounted thereon to cover said side tube, said inner bar and said front tube

6. The handcart as defined in claim 5, wherein said shell has an inclined surface at the front end thereof.

7. The handcart as defined in claim 5, wherein said shell is provided with at least a resistance element thereon.

8. The handcart as defined in claim 5, wherein said shell is provided with a front board at the front side thereof.

9. The handcart as defined in claim 6, wherein said shell is provided with a front board at the front side thereof wherein said front board has an inclined surface parallel to said inclined surface of said shell.

10. The handcart as defined in claim 1, wherein each of said side tubes and said inner bar has an arched portion at rear ends thereof and a block at the edge of said arched portion.
